(19) United States
(12) Patent Application Publication
(10) Pub. No.: US 2004/0072043 A1
(43) Pub. Date: Apr. 15, 2004

(54) Fuel cell system

(76) Inventors: Takashi Hashimoto, Yokosuka-shi, Kanagawa (JP); Shizuo Yamamoto, Yokosuka-shi, Kanagawa (JP); Katsuyuki Fujii, Yokosuka-shi, Kanagawa (JP); Hitoshi Shimonosono, Yokohama-shi, Kanagawa (JP)

Correspondence Address: McDermott Will & Emery, 600 13th Street NW, Washington, DC, 20005-3096, US

(21) Appl. No.: 10/363,901

(22) PCT Filed: Oct. 16, 2002
(86) PCT No.: PCT/JP02/10732

(30) Foreign Application Priority Data
Dec. 3, 2001 (JP) NO 2001-368355

(51) Int. Cl. H01M 8/04; H01M 8/12; H01M 2/14; H01M 8/18

(52) U.S. Cl. 429/25; 429/19; 429/20; 429/22; 429/24; 429/26; 429/38; 429/39

(57) ABSTRACT

A fuel cell 11, supply gas passages 12a, 12b which supply gas for power generation to the fuel cell 11, and an antifreeze passage 15 adjacent to the supply gas passages 12a, 12b via a partition 14 which selectively passes pure water installed in the fuel cell 11 or upstream of it, are provided, water is transferred from the antifreeze passage 15 to the supply gas passages 12a, 12b by the steam partial pressure difference between the antifreeze and supply gas at the partition 14, and the supply gas is thereby humidified.

### FIELD OF THE INVENTION

This invention relates to a fuel cell system for vehicles, and in particular to a fuel cell requiring humidification.

### BACKGROUND OF THE INVENTION

JP9-7621A published by the Japanese Patent Office in 1997 describes a system wherein water is led directly to fuel cell stack in the liquid phase, and the gas supplied to the fuel cell stack is humidified via a porous material. According to this method, the gas is made to circulate on one side of a gas humidification plate of a humidification area comprising a porous carbon plate having perimeter with a gas seal, and the pure water after fuel cell stack cooling is circulated at a pressure slightly higher than the gas on the other side so as to perform gas humidification.

### SUMMARY OF THE INVENTION

However, in the above-mentioned prior art humidification system, if insulation properties are taken into consideration, the water for cooling and humidification which is led to the fuel cell stack must be pure water with very low electrical conductivity. It may occur therefore that this pure water freezes at the very low temperature level of −20° C. Moreover, a volume change occurs in pure water due to the phase change of freezing, and the heat exchanger may be damaged.

It is therefore an object of this invention to humidify the gas supply to a fuel cell stack even at freezing point and at very low temperature, and enabling it to start.

In order to achieve above object, the present invention provides a fuel cell system, comprising a fuel cell, a supply gas passage which supplies gas for power generation to the fuel cell, and a first antifreeze passage adjacent to the supply gas passage via a partition which selectively passes pure water from antifreeze, the partition being installed inside the fuel cell or upstream from the fuel cell. Water is transferred to the supply gas passage from the first antifreeze passage by the difference of the steam partial pressure of the antifreeze and the steam partial pressure of the supply gas at the partition, and the supply gas in the supply gas passage is thereby humidified.

The details as well as other features and advantages of this invention are set forth in the remainder of the specification and are shown in the accompanying drawings.

### BRIEF DESCRIPTION OF THE DRAWINGS

FIG. 1 is a schematic description of a fuel cell system for vehicles relating to this invention (first embodiment).

FIG. 2 shows a partial modification of the first embodiment.

FIG. 3 is a schematic view of a second embodiment of this invention.

FIG. 4 is a flowchart of supply gas humidification control.

FIG. 5 shows a partial modification of the second embodiment.

FIG. 6 is a schematic view of a third embodiment of this invention.

FIG. 7 shows a partial modification of the third embodiment.

FIG. 8 is a schematic view of a fourth embodiment of this invention.

FIG. 9 shows a partial modification of the fourth embodiment.

### DESCRIPTION OF THE PREFERRED EMBODIMENTS

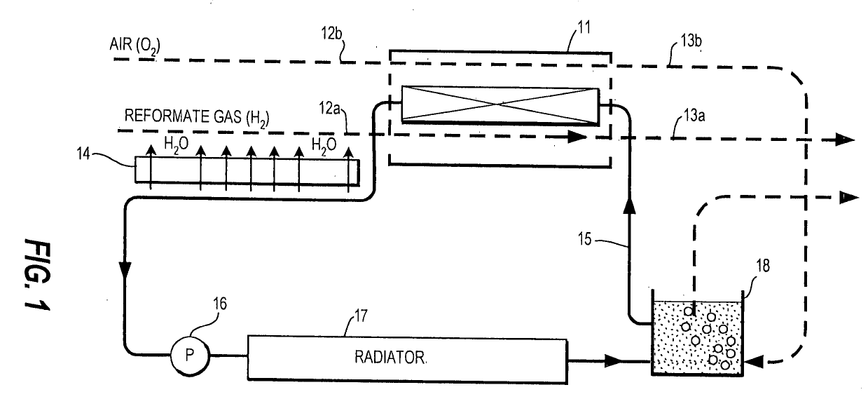

Referring to FIG. 1 of the drawings, a fuel cell stack 11 of a fuel cell system for vehicles relating to this invention is provided with supply gas passages 12a, 12b which supply reformate gas and air to an anode (fuel pole) and a cathode (air pole), respectively, and exhaust gas passages 13a, 13b for discharging anode exhaust gas and cathode exhaust gas.

A partition 14 which selectively allows pure water in antifreeze to pass is formed upstream of the fuel cell stack 11. The partition 14 may for example be an ion exchange membrane. On one side of the partition 14, the supply gas led to the fuel cell stack 11 flows, and on the other side, antifreeze which provides water for humidifying the supply gas flows, respectively. The antifreeze is for example a long life coolant (LLC, mixture of water and ethylene glycol). The gas which comes in contact with the partition 14 is reformate gas in FIG. 1, but the gas which comes in contact with the partition 14 may also be air supplied to the cathode. Also, the partition 14 may also be in contact with both reformate gas and air. When pure hydrogen is supplied to the fuel cell stack from a hydrogen tank, the gas which comes in contact with the partition 14 may be pure hydrogen (same for other embodiments).

A pump 16 for circulating antifreeze, radiator (heat exchanger) 17 which cools the antifreeze by heat exchange between the antifreeze and the outside air, and a recovery tank 18 which is a recovery device, are formed in an antifreeze passage 15.

After cooling of the fuel cell stack 11, the antifreeze is led to the partition 14. The antifreeze led to the partition 14 is at high temperature due to the heat received from the fuel cell stack 11, and is at a temperature at which the steam partial pressure is higher than the steam partial pressure of the supply gas flowing on the opposite side of the partition 14. Therefore, the partition 14 allows pure water to selectively penetrate from the antifreeze side at a high steam partial pressure to the supply gas side at a low steam partial pressure, so the supply gas led to the fuel cell stack 11 is humidified by the water supplied via the partition 14.

The antifreeze which passed through a part in contact with the partition 14 is led to the radiator 17 which performs heat exchange with the outside air. After being cooled by the radiator 17 below the dew point temperature of the exhaust gas, the antifreeze is led to the recovery tank 18. Thus, the recovery tank 18 is filled with antifreeze below the dew point temperature of the exhaust gas from the fuel cell stack 11. Also, in addition to antifreeze, the exhaust gas passage 13b from the cathode of the fuel cell stack 11 is led to the recovery tank 18. The exhaust gas from the fuel cell stack 11 contains a large amount of water generated as a side product during power generation.

The exhaust gas is introduced to the antifreeze in the recovery tank 18 by bubbling. Due to the air lift pump action (convection produced in the recovery tank 18) resulting from the buoyancy of the generated air bubbles, the generated water and heat contained in the exhaust gas are collected by the antifreeze. The water in the antifreeze decreases when it passes by the partition 14, but the water is recovered in the recovery tank 18, so the water in the antifreeze is kept effectively constant. In this way, a water balance is established even if a supplementary means of supplying water, such as a pure water tank, is not provided.

The temperature of the antifreeze is lowest at the outlet of the radiator 17, so to lower the antifreeze temperature in the recovery tank 18 below the dew point temperature of the exhaust gas, it is most effective to position the recovery tank 18 near the outlet of the radiator 17.

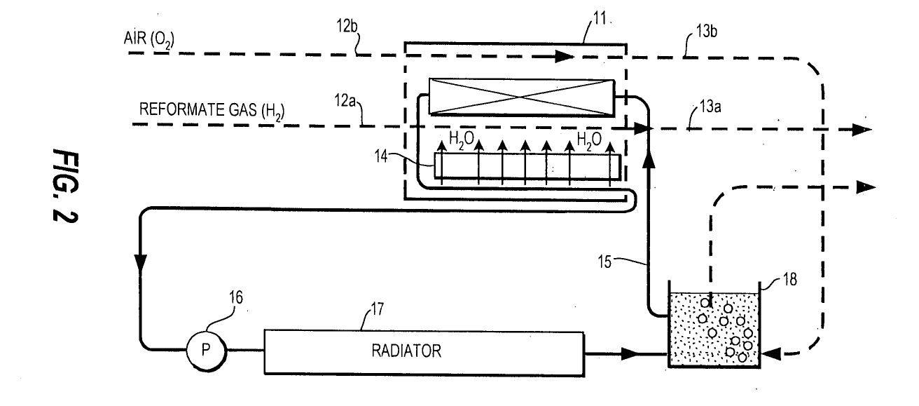

In FIG. 1, although the gas supplied to the fuel cell stack 11 is humidified just before the fuel cell stack 11, the partition 14 may be formed inside the fuel cell stack 11 as shown in FIG. 2, and the gas supplied to the fuel cell stack 11 may be humidified inside the fuel cell stack 11.

Next, a second embodiment will be described.

Also in the second embodiment, as in the first embodiment, the supply gas is humidified by the pure water separated from the antifreeze by the partition 14, and the water and heat are recovered from the exhaust gas by the antifreeze in the recovery tank 18.

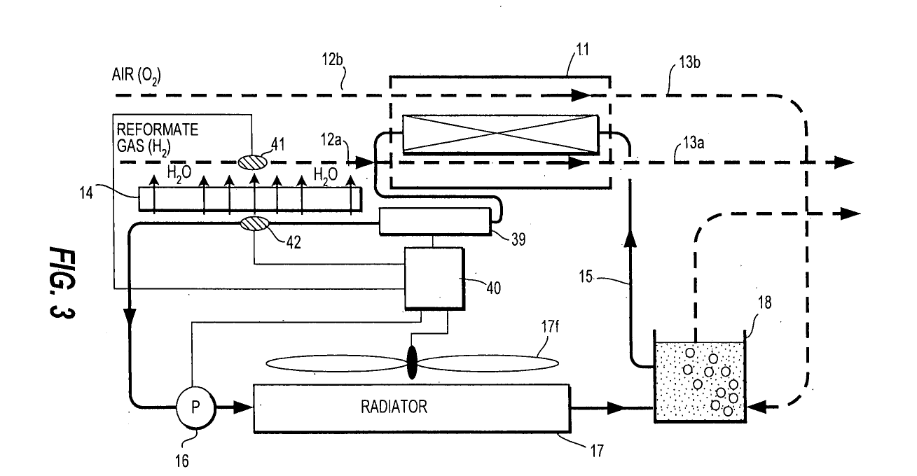

FIG. 3 shows a schematic view of the second embodiment. The fuel cell stack 11 is provided with the supply gas passages 12a, 12b and exhaust gas passages 13a, 13b. The partition 14 which allows pure water from the antifreeze to pass selectively is formed upstream of the fuel cell stack 11. On one side of the partition 14, supply gas led to the fuel cell stack 11 flows, and on the other side, the antifreeze for supplying water for humidifying the supply gas flows, respectively.

The pump 16 which circulates antifreeze, and the radiator 17 which cools the antifreeze by performing heat exchange between the outside air and the antifreeze, are provided in the antifreeze passage 15. The radiator 17 can adjust the heat discharge amount by adjusting the rotation speed of a cooling fan 17f. The recovery tank 18 is provided in the antifreeze passage 15. The exhaust gas passage 13b from the cathode of the fuel cell stack 11 is led to the recovery tank 18.

A temperature control device 39, such as a heater, is provided between the outlet of the fuel cell stack 11 of the antifreeze passage 15, and the partition 14. Temperature sensors 41, 42 which measure the temperature of the antifreeze led to the partition 14 and the temperature of the supply gas led to the partition 14 are installed at sites where the partition 14 is in contact with antifreeze and supply gas. The temperature sensors 41, 42 and the temperature control device 39, the pump 16 and radiator 17 are electrically connected to a controller 40. The controller 40 comprises one, two or more microprocessors, a memory, and an input and output interface, and performs humidification control described below.

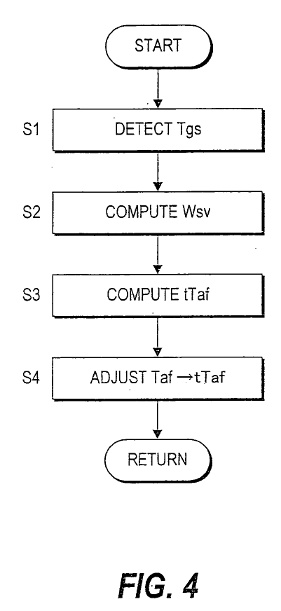

FIG. 4 is a flowchart showing the details of supply gas humidification control performed by the controller 40, and it is executed at a predetermined interval (for example, 10 msec).

In humidification control, firstly, a temperature Tgs of the supply gas to the fuel cell stack 11 in contact with the partition 14 is measured by the temperature sensor 41 (step S1), and a saturated steam amount Wsv of the supply gas is computed (step S2).

Next, a temperature (antifreeze target temperature) tTaf required for the antifreeze to supply a water amount which corresponds to the saturated steam amount Wsv via the partition 14 is computed (step S3). While monitoring of the antifreeze temperature Taf by the temperature sensor 42, the heating amount of the temperature control device 39 provided in the antifreeze passage 15, the flowrate of the pump 16 and the heat dissipation performance of the radiator 17 are adjusted so that the antifreeze temperature Taf is the antifreeze target temperature tTaf (step S4).

Due to this, as compared with the preceding embodiment, fine humidification control is possible depending on the operating state of the fuel cell stack 11, and the supply gas can be humidified very efficiently.

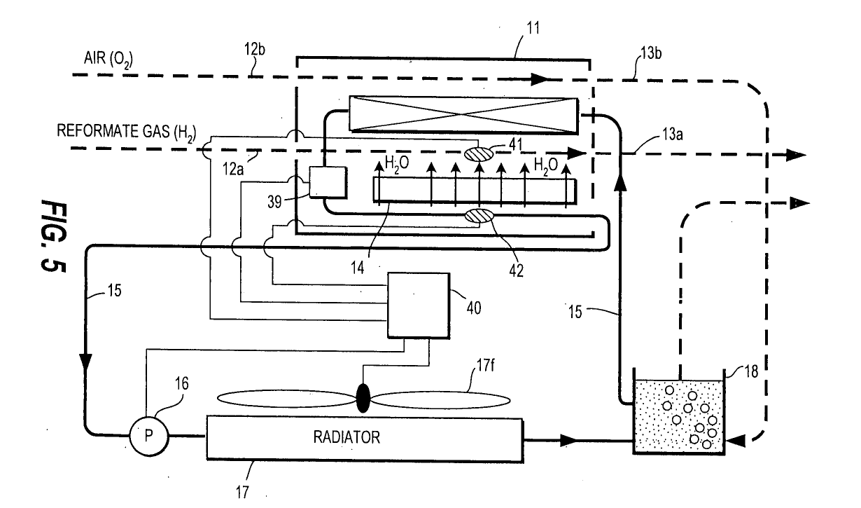

In FIG. 3, although the supply gas led to the fuel cell stack 11 is humidified just before the fuel cell stack. 11, the partition 14 may be formed inside the fuel cell stack 11, and the gas supplied to the fuel cell 11 may be humidified inside the fuel cell stack 11 as shown in FIG. 5.

Next, a third embodiment will be described.

In the third embodiment, as in the preceding embodiment, the supply gas is humidified by the pure water separated from the antifreeze by the partition 14, the water and heat in the exhaust gas are recovered by the antifreeze in the recovery tank 18, and the temperature of the antifreeze is controlled by adjusting the heating amount of the temperature control device 39 in the antifreeze passage 15 based on the temperature of the supply gas and temperature of antifreeze in contact with the partition 14, the recirculation amount of the pump 16, and the heat dissipation performance of the radiator 17.

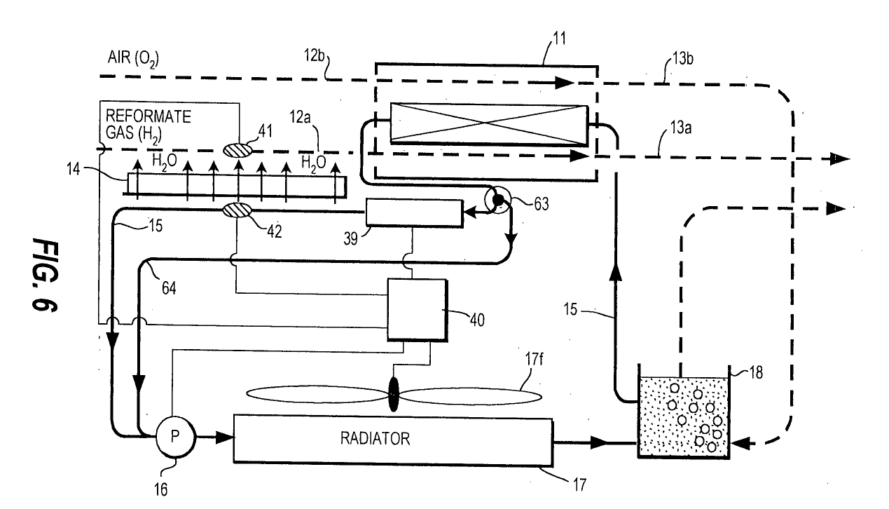

FIG. 6 shows a schematic view of the third embodiment.

The fuel cell stack 11 is provided with the supply gas passages 12a, 12b and exhaust gas passages 13a, 13b. The partition 14 which selectively allows pure water from the antifreeze to pass is formed upstream of the fuel cell stack 11. On one side of the partition 14, the supply gas led to the fuel cell stack 11 flows, and on the other side, antifreeze for providing the water for humidifying the supply gas flows, respectively.

The pump 16 which circulates the antifreeze and the radiator 17 which cools the antifreeze by performing heat exchange between the outside air and the antifreeze, are provided in the antifreeze passage 15. The radiator 17 can adjust the heat discharge amount by adjusting the rotation speed of the cooling fan 17f. The recovery tank 18 is provided in the antifreeze passage 15. The exhaust gas passage 13b from the cathode of the fuel cell stack 11 is led to the recovery tank 18.

The temperature control device 39, such as a heater, is installed between the stack outlet of the antifreeze passage 15, and the partition 14. The temperature sensors 41, 42 which measure the temperature of the antifreeze led to the partition 14 and the temperature of supply gas led to the partition 14 are installed at the sites where the antifreeze and supply gas are in contact with the partition 14. The temperature sensors 41, 42 and temperature control device 39, pump 16 and radiator 17 are electrically connected with the controller 40.

A flowrate adjusting device 63, such as a thermostat, is provided between the outlet of the fuel cell stack 11 of the antifreeze passage 15, and the temperature control device 39. A by-pass passage 64 which bypasses the temperature control device 39 and partition 14 branches off from the flowrate adjusting device 63. The by-pass passage 64 is connected to the antifreeze passage 15 before the pump 16.

Due to the above-mentioned construction, even when further warming at the temperature control device 39 by the antifreeze is required, only the minimum amount of antifreeze required to humidify the supply gas is led to the partition 14, and the remaining antifreeze can be circulated directly to the radiator 17 via the by-pass passage 64 to be cooled.

Consequently, the heat energy supplied to the antifreeze from the temperature control device 39 for supply gas humidification is the absolute minimum required, and the load on the temperature control device 39 can be mitigated. Also, the heat amount which must be cooled by the radiator 57 can be minimized, and the thermal efficiency in the fuel cell system can be improved.

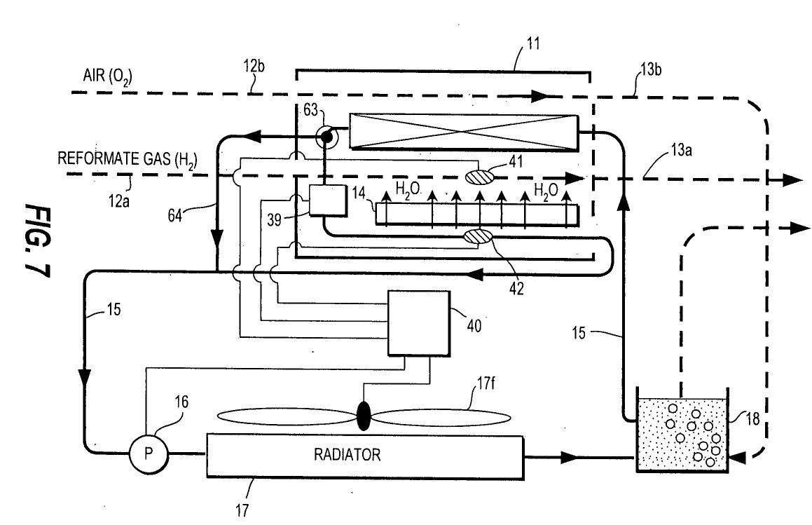

In FIG. 6, although the supply gas led to the fuel cell stack 11 is humidified just before the fuel cell stack 11, the partition 14 may be formed inside the fuel cell stack 11, and humidification may be performed inside the fuel cell stack 11 as shown in FIG. 7.

Next, a fourth embodiment will be described.

In the fourth embodiment, as in the preceding embodiment, the supply gas is humidified by the water separated from the antifreeze by the partition 14, the water and heat in the exhaust gas are recovered by the antifreeze in the recovery tank 18, and the temperature of the antifreeze is controlled by adjusting the heating amount of the temperature control device 39 in the antifreeze passage 15 based on the temperature of the supply gas and temperature of antifreeze in contact with the partition 14, the recirculation amount of the pump 16, and the heat dissipation performance of the radiator 17.

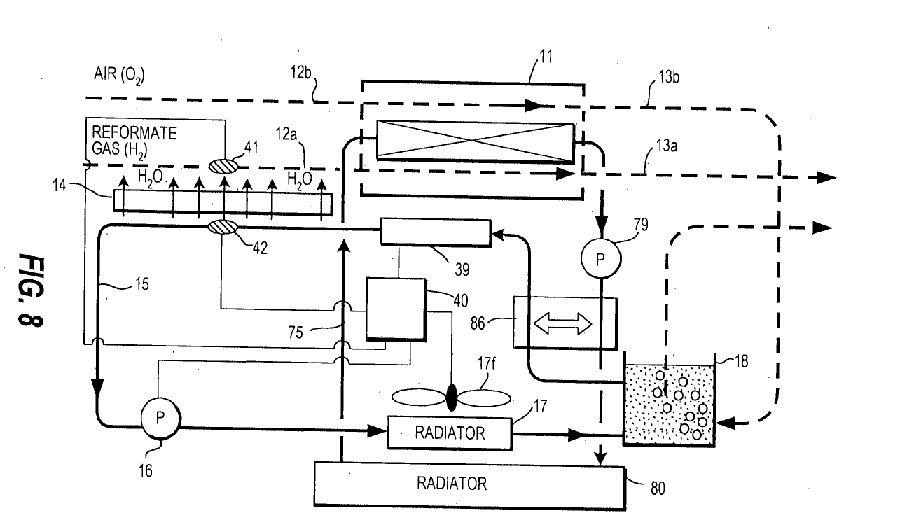

FIG. 8 shows a schematic view of the fourth embodiment.

The fuel cell stack 11 is provided with the supply gas passages 12a, 12b and the exhaust gas passages 13a, 13b. The partition 14, which allows pure water from the antifreeze to pass selectively, is formed upstream of the fuel cell stack 11. On one side of the partition 14, supply gas led to the fuel cell stack 11 flows, and on the other side, antifreeze for providing water for humidifying the supply gas flows, respectively.

The fuel cell system has an antifreeze passage 15 for humidification of supply gas, and an antifreeze passage 75 (second antifreeze passage) for cooling of the fuel cell stack 11. The pump 16 which circulates antifreeze, the radiator 17 which cools the antifreeze by performing heat exchange between the outside air and antifreeze in the antifreeze passage 15, and the recovery tank 18, are provided in the antifreeze passage 15. The exhaust gas passage 13b is connected to the recovery tank 18, and introduces exhaust gas from the cathode. A pump 79 which circulates the antifreeze, and a radiator 80 which cools the antifreeze by performing heat exchange between the outside air and the antifreeze in the second antifreeze passage 75, are formed in the second antifreeze passage 75. The radiators 17, 80 can adjust the heat dissipation performance by adjusting the rotation speed of the cooling fan 17f.

The temperature control device 39, such as a heater, is provided between the recovery tank 18 of the antifreeze passage 15, and the partition 14. The temperature sensors 41, 42 which measure the temperature of the antifreeze led to the partition 14 and the temperature of the supply gas led to the partition 14 are formed at sites where the antifreeze and supply gas come in contact with the partition 14. The temperature sensors 41, 42, temperature control device 39, pump 16 and radiator 17 are electrically connected with the controller 40.

The antifreeze of the antifreeze passage 15 is led to the partition 14. On the opposite side of the partition 14 to the antifreeze passage 15, the supply gas led to the fuel cell stack 11 flows. The temperature control of the antifreeze led to the partition 14 is performed by the controller 40. The details of the temperature control of the antifreeze are identical to those shown in FIG. 4.

Due to the temperature control of the antifreeze, the partition 14 selectively allows pure water to pass from the antifreeze side at high steam partial pressure to the supply gas side at low steam partial pressure, and the supply gas led to the fuel cell stack 11 is humidified by the water supplied from the antifreeze via the partition 14.

The antifreeze which passed through the partition 14 is cooled by the radiator 17 which performs heat exchange with the outside air, and is led to the recovery tank 18. In addition to the antifreeze led to the antifreeze passage 15, the exhaust gas passage 13b from the cathode of the fuel cell stack 11 is led to the recovery tank 18. The discharge gas contains a large amount of water generated as a side product during power generation by the fuel cell stack 11.

When the antifreeze is cooled by the radiator 17, it is cooled below the dew point temperature of the exhaust gas led to the recovery tank 18. Therefore, the inside of the recovery tank 18 is filled with antifreeze which is below the dew point temperature of the exhaust gas. Bubbling of exhaust gas is performed by introducing exhaust gas into the antifreeze in the recovery tank 18. Due to the air lift pump action resulting from the buoyancy of the air bubbles generated, the water component and heat contained in the stack exhaust gas are both recovered by the antifreeze. Hence, the antifreeze which lost water at the partition 14 can recover water, and the water balance of the fuel cell system can be established without providing any separate means to supplement water, such as a pure water tank.

In this embodiment, the antifreeze passage 75 for cooling the fuel cell stack 11 and the antifreeze passage 15 for supply gas humidification are independent. Thus, circulation flowrate and temperature can be controlled separately, and separate control targeted at stack cooling and supply gas humidification can be performed.

Further, a heat exchanger 86 which performs heat exchange between the outlet of the fuel cell stack 11 in the antifreeze passage 75 and outlet of the recovery tank 18 in the antifreeze passage 15, is provided. In the heat exchanger 86, heat exchange is performed between hot antifreeze after cooling the fuel cell stack 11 in the antifreeze passage 75, and the antifreeze in the antifreeze passage 15 led to the partition 14 for supply gas humidification. Due to this heat exchange, the temperature of the antifreeze led to the partition 14 is increased, and the heating load of the temperature control device 39 can be mitigated. Also, the temperature of the antifreeze sent to the radiator 80 can be lowered, and the thermal load of the radiator 17 can be lowered.

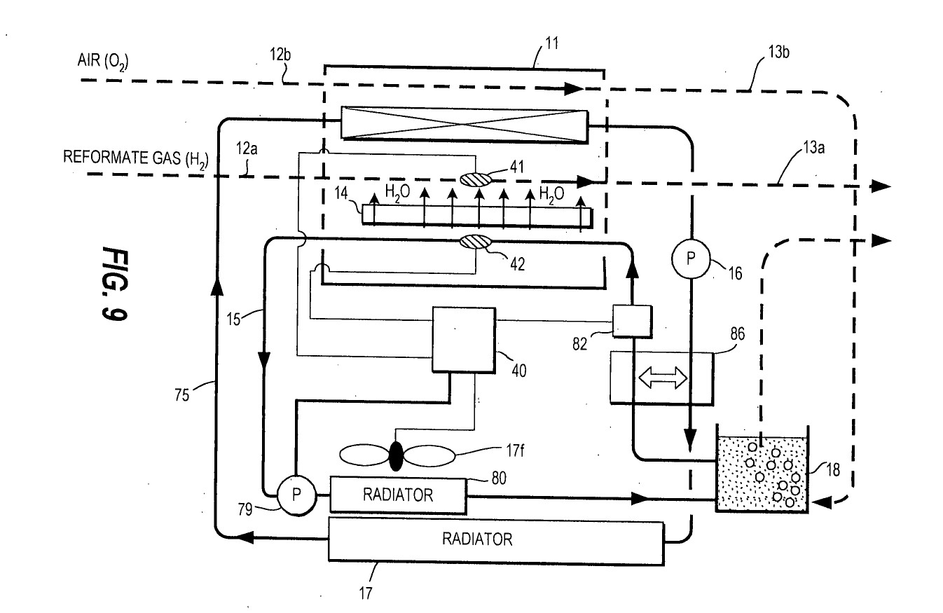

In FIG. 8, although the supply gas led to the fuel cell stack 11 is humidified just before the stack, a partition 14 may be formed inside the fuel cell stack 11, and the supply gas may be humidified inside the fuel cell stack 11 as shown in FIG. 9.

In the above first to fourth embodiments, although an ion exchange membrane is used as the partition 14 which allows pure water from the antifreeze to pass selectively, any member can be used as the partition provided it has an identical function.

Also, a long life coolant is used as an antifreeze, but any mixed liquid may be used as the antifreeze provided that it does not freeze at very low temperature, and pure water can be separated by the above-mentioned partition, i.e., provided that it is a mixed liquid having molecules of such a size that they can be separated from pure water by the above-mentioned partition.

The entire contents of Japanese Patent Application P2001-368355 (filed Dec. 3, 2001) are incorporated herein by reference.

Although the invention has been described above by reference to a certain embodiment of the invention, the invention is not limited to the embodiment described above. Modifications and variations of the embodiments described above will occur to those skilled in the art, in the light of the above teachings. The scope of the invention is defined with reference to the following claims.

### INDUSTRIAL FIELD OF APPLICATION

This invention is applicable to various fuel cell systems, including those used in vehicles. According to this invention, humidification of gas for power generation supplied to a fuel cell is performed by water supplied from an antifreeze passage via a partition, and pure water is unnecessary as water for humidification. The liquid phase in the fuel cell system is only antifreeze, so water does not freeze in the system, the supply gas can be humidified and the fuel cell system can be started even below freezing point at very low temperature (including the −50° C. level).

1. A fuel cell system, comprising:
a fuel cell (11),
a supply gas passage (12a, 12b) which supplies gas for power generation to the fuel cell (11), and
a first antifreeze passage (15) adjacent to the supply gas passage (12a, 12b) via a partition (14) which selectively passes pure water from antifreeze, the partition (14) being installed inside the fuel cell (11) or upstream from the fuel cell (11),
wherein water is transferred to the supply gas passage (12a, 12b) from the first antifreeze passage (15) by the difference of the steam partial pressure of the antifreeze and the steam partial pressure of the supply gas at the partition (14), and the supply gas in the supply gas passage (12a, 12b) is thereby humidified.

2. The fuel cell system as defined in claim 1, wherein a recovery device (18) is provided in the first antifreeze passage (15) whereof the temperature is adjusted below the dew point temperature of the exhaust gas from the fuel cell (11), and the water and heat of the exhaust gas is recovered to the first antifreeze passage (15) by passing the exhaust gas through the recovery device (18).

3. The fuel cell system as defined in claim 2, wherein the recovery device (18) is filled with antifreeze below the dew point temperature of the discharge gas, the water and heat of the exhaust gas is recovered by bubbling, and the recovered water and heat are added to the antifreeze.

4. The fuel cell system as defined in claim 1, further comprising a temperature control device (39) which adjusts the temperature of the antifreeze so that the steam partial pressure of the antifreeze is higher than the steam partial pressure of the supply gas.

5. The fuel cell system as defined in claim 4, further comprising:
a sensor (41) which detects the temperature of the supply gas, and
a controller (40) which functions to compute a target temperature of the antifreeze based on the detected supply gas temperature and adjust the temperature of the antifreeze by the temperature control device (39) so that the temperature of the antifreeze is the antifreeze target temperature.

6. The fuel cell system as defined in claim 4, further comprising:
a bypass passage (64) which bypasses the partition (14) in the first antifreeze passage (15), and
a flowrate adjusting device (63) which adjusts the flowrate of the bypass passage (64) according to the antifreeze temperature.

7. The fuel cell system as defined in claim 2, further comprising:
a second antifreeze passage (75) for cooling the fuel cell (11) which is independent of the first antifreeze passage (15).

8. The fuel cell system as defined in claim 7, wherein:
a heat exchanger (86) which performs heat exchange between the antifreeze after cooling of the fuel cell (11) in the second antifreeze passage (75) and the antifreeze upstream of the partition (14) in the first antifreeze passage (15), is further provided downstream of the recovery device (18) of the first antifreeze passage (15).
